(19) United States
(12) Patent Application Publication
(10) Pub. No.: US 2018/0098227 A1
(43) Pub. Date: Apr. 5, 2018

(54) Moving Mobile Wireless Vehicle Network Infrastructure System and Method

(71) Applicant: KABUSHIKI KAISHA TOSHIBA, Tokyo (JP)

(72) Inventors: Pietro E. CARNELLI, Bristol (GB); Mahesh SOORIYABANDARA, Bristol (GB)

(73) Assignee: KABUSHIKI KAISHA TOSHIBA, Tokyo (JP)

(21) Appl. No.: 15/504,050

(22) PCT Filed: Jun. 9, 2015
(86) PCT No.: PCT/GB2015/051693

§ 371 Date: Feb. 15, 2017

(51) Int. Cl. H04W 16/18; H04W 4/02; H04W 24/02; H04W 84/00

(52) U.S. Cl. CPC H04W 16/18; H04W 4/028; H04W 84/005; H04W 4/04; H04W 24/02

(57) ABSTRACT

Moving Mobile Wireless Vehicle Network Infrastructure System and Method A system and method for managing a dynamic wireless network comprising at least one movable wireless access point configured to be carried by a vehicle. The method comprises monitoring at least part of the network and determining one or more locations of demand for a wireless access point and receiving location data indicating the current location of the movable wireless access point. The method further comprises determining a route for the vehicle, the route being from the current location of the movable wireless access point and towards one of the one or more locations of demand so that the movable wireless access point may provide wireless network coverage to the location of demand for at least part of the route.

### FIELD

Embodiments described herein relate generally to movable wireless access points configured to be carried by vehicles, methods of managing movable wireless access points and systems and methods for managing dynamic wireless networks comprising movable wireless access points.

### BACKGROUND

As the proportion of the world population living in urban environments increases, the demand for improving existing urban transportation infrastructure has never been greater; however, adding to existing transport infrastructure is often too complicated and costly to accomplish.

Not only is the proportion of people living in urban areas increasing, so is (to an even greater extent) the number of wirelessly connected devices. Many researchers and firms in the field estimate that by 2020 data traffic could increase by around 1,000 to 10,000 times the current amount.

There is therefore a strong need for an improved wireless infrastructure capable of providing fast, reliable Internet access to the vast majority of the population, regardless of where they live, with ultra-low latency, huge scalability and dynamic demand response.

### BRIEF DESCRIPTION OF THE DRAWINGS

Embodiments of the present invention will be understood and appreciated more fully from the following detailed description taken in conjunction with drawings in which:

FIG. 1 shows a movable wireless access point according to an embodiment of the invention;

FIG. 2 shows the various states in which a movable wireless access point may operate;

FIG. 3 shows a moving mobile wireless vehicle network infrastructure system (MMWVNIS) according to an embodiment;

FIG. 4 shows a flow chart of the process of determining a route and following the route towards a destination;

FIG. 5 shows the message sequence between a movable wireless access point and a central server for an initial start phase of a journey;

FIG. 6 shows the message sequence between a movable wireless access point and a central server as the movable wireless access point is travelling;

FIG. 7 shows the message sequence between a movable wireless access point and a central server for the end of a journey; and

FIG. 8 shows a central server configured monitor network performance and determine routes for movable wireless access points accordingly.

### DETAILED DESCRIPTION

Wireless communication systems enable elements within the transportation system such as vehicles, trains, buses, lorries and traffic lights to become more intelligent by using wireless technology to communicate with each other, thus reducing the need for humans to be in control of the various elements of the transportation network. Semi or fully autonomous vehicles have shown to bring about significant improvements in the overall transportation network performance, reduction in energy usage, road network capacity, reductions in congestion, safer journeys and increased traveller convenience. Autonomous vehicles are vehicles that can drive themselves without human interaction. Semi-autonomous vehicles are vehicles that are controlled by a user but also provide aid to the user, such as by slowing the car down based on knowledge of a collision ahead, or by keeping the car within a given lane. Given the number of advantages associated with semi and fully autonomous vehicles, it is envisioned that these will be at the forefront of future transportation systems.

In order for fully autonomous vehicles to become a consumer reality, several systems require improvement. A large amount of research has been conducted in order to improve current imaging and image processing technologies to inform said vehicles of decisions to be made as they travel along their route; however, it has been widely acknowledged that, in order to detect obstacles and make decisions (such as route planning or vehicle avoidance) in a timely manner, an autonomous vehicle wireless communication system is required. This is particularly important when obstacles are outside the line of sight of the vehicle.

Vehicle-to-vehicle (V2V) and vehicle-to-infrastructure (V2I) networks are often cited as the solution to these problems as they allow vehicles to communicate with each other for safety and to ensure better road utilisation. In addition, a central infrastructure can allow vehicles to download the latest map updates as well as any other critical updates such as bad weather, or road works in the area. This can allow autonomous vehicles to make more intelligent decisions earlier. Such decisions may relate to traffic, routing to destination, safety, parking, charging and/or refuelling.

Embodiments of the invention aim to help solve the problem of increased internet and cellular data traffic by using vehicles as wireless access points for users both inside and outside of the vehicle to connect compatible devices to the vehicle, in order to then route data through either or both of the vehicle-to-vehicle (V2V) and vehicle-to-infrastructure (V2I) wireless communication networks.

According to one embodiment there is provided a method of managing a dynamic wireless network comprising at least one movable wireless access point configured to be carried by a vehicle. The method comprises monitoring at least part of the network and determining one or more locations of demand for a wireless access point and receiving location data indicating the current location of the movable wireless access point. The method further comprises determining a route for the vehicle, the route being from the current location of the movable wireless access point and towards one of the one or more locations of demand so that the movable wireless access point may provide wireless network coverage to the location of demand for at least part of the route.

By providing vehicles with movable wireless access points, embodiments of the invention allow the vehicles to provide wireless coverage and to be directed to areas of demand for wireless access points in order to improve service across the network. This may be implemented simply and effectively with few modifications to the systems already required for autonomous vehicles. Having said this, embodiments may equally be applied to semi-autonomous or manual vehicles.

The method may be implemented in a network management system (e.g. a centralised server configured to manage the dynamic wireless network) or may be implemented in the movable wireless access point itself.

The route being towards the one or more locations of demand means that, as the vehicle moves along the route, it gets closer to, but not necessarily heads directly towards, the one or more locations of demand. The locations of demand may form part of one or more areas of demand. Where the vehicle is autonomous, the route may be a route directing the vehicle from a parked position or from a drop-off position where a passenger or goods have been delivered, to a new parked position to provide improved network service. A shall be discussed below, the route may also be from the current location, to a destination specified by the user.

In one embodiment, determining a location of demand includes determining an area of demand for a wireless access point. The area may encompass the location. Determining the route may comprise determining a route that passes within a predetermined distance of the location of demand (or the area of demand) to allow the movable wireless access point to provide wireless network coverage to the location of demand or at least part of the area of demand.

A location of demand for a wireless access point may be dictated by the overall needs of the network. For instance, in one embodiment, monitoring at least part of the network comprises monitoring one or more of coverage, quality of service and user demand for at least part of the network. A location of demand for a wireless access point may be one where user demand is above a first threshold, quality of service is below a second threshold, and/or coverage is below a third threshold. These thresholds may be set by the network provider and may vary based on the area and previous usage. Quality of service may be measured in a variety of ways. Quality of service may indicate error rates, bandwidth, throughput, transmission delay, availability, jitter and/or any other indication of the quality of wireless service provided. User demand may be the number of devices connected, the amount of data transferred and/or any other indication of the demand for wireless access.

The location of demand may be a location of current demand or a location of expected demand based on historical network data associated with a corresponding time in the past. According to one embodiment the one or more locations of demand are determined based on historical and/or current network parameters which comprise one or more of the amount of data used in an area, the number of wireless devices in an area, the ratio of the number of wireless devices in the area to the number of access points in the area and the ratio of the amount of data used in the area to the total available bandwidth in the area.

According to an embodiment the method further comprises receiving data indicating a desired destination for the movable wireless access point. Determining the route comprises determining a route from the current location of the movable wireless access point to the desired destination and which approaches or passes the location of demand to allow the movable wireless access point to provide wireless network coverage to the location of demand for at least part of the route. This allows the vehicle to travel to the desired destination whilst taking a route which allows the movable wireless access point to improve network service.

According to a further embodiment, the method further comprises receiving an updated location of the movable wireless access point, determining whether the updated location is within a predefined distance from the desired destination, and determining an updated destination and a route to the updated destination, wherein the updated destination and route are determined based local demand for a wireless access point. This provides the movable wireless access point with a position to park which provides improved network service. The position may be after passengers and goods have been dropped off (e.g. after the vehicle has reached its desired destination), or may be a final destination for delivering passengers and goods, wherein the final destination is determined to be within a predefined destination of the desired destination.

In one embodiment, monitoring traffic data to determine one or more areas of increased traffic density and wherein the route is determined based on the traffic data to avoid at least one of the one or more areas of increased traffic density. This allows the route to be planned to avoid dense traffic and therefore provide a quicker route.

In one embodiment, the method further comprises, subsequent to sending the route, continuing to monitor at least part of the network and determining one or more updated locations of demand for a wireless access point, receiving an updated location of the movable wireless access point, and determining an updated route for the movable wireless access point based on the updated location and one of the one or more updated locations of demand. This allows the route to be updated based on new network information even as the vehicle is travelling.

In one embodiment the method further comprises receiving energy reserve data indicating the energy reserves of the vehicle. When the energy reserves of the vehicle are below a predefined value, the route is determined to pass or end at a refuelling or recharging station. This diverts the vehicle to a refuelling or recharging station to avoid the vehicle running out of energy.

According to one embodiment, the method further comprises receiving network usage data from a number of movable wireless access points, and, based on the network usage data, issuing instructions to one or more movable wireless access points to at least partially disable wireless communication to save energy. This allows the network to save energy should user demand be low in a specific area.

According to a further aspect of the invention there is provided a device for managing a dynamic wireless network comprising at least one movable wireless access point configured to be mounted on vehicle, the device comprising a controller configured to receive data relating to data usage across at least part of the network, and monitor the network and determine one or more locations of demand for a wireless access point. The controller is further configured to receive location data indicating the current location of the movable wireless access point and determine a route for the vehicle, the route being from the current location of the movable wireless access point and towards one of the one or more locations of demand so that the movable wireless access point may provide wireless network coverage to the location of demand for at least part of the route.

Data relating to data usage may specify the quality of service, the coverage and/or the user demand across at least part of the network. It may comprise data specifying the amount of data used across at least part of the network and/or being used across at least part of the network. It may also comprise the number of wireless devices accessing and/or capable of accessing at least part of the network. In addition, it may comprise the number of wireless access points available across at least part of the network and/or the total available bandwidth for at least part of the network. Data relating to data usage may include historical data and/or current data.

According to an additional aspect of the invention there is provided a movable wireless access point configured to be mounted on a vehicle and comprising a wireless module configured to connect wirelessly to the internet, and provide local wireless network coverage, a position module configured to determine the location of the movable wireless access point, and a controller. The controller is configured to send location data indicating the current location of the movable wireless access point to a network management system, receive a route for the vehicle, the route directing the wireless access point towards one or more locations of demand for a wireless access point so that the movable wireless access point may provide wireless network coverage to the one or more locations of demand for at least part of the route, and issue an instruction to move the vehicle based on the route.

This allows the movable wireless access device to be moved to improve network service at a location of demand for a wireless access device. In one embodiment the vehicle is configured to be controlled manually or semi-autonomously by a user and the instruction is an instruction to the user to move the vehicle according to the route. In an alternative embodiment, the vehicle is an autonomous vehicle and the instruction is an instruction to the autonomous vehicle to follow the route. Accordingly, the vehicle may be autonomous, semi-autonomous or manual. In addition, the vehicle may be land based (car, motorbike), water based (boat, ship) or air based (aircraft or drone). Generally, the vehicle may be any platform capable of carrying the movable wireless access point and providing or harnessing a driving force to move.

The connection to the internet may be via a local base station to access a cellular network or may be via a movable wireless access point as part of a mesh network. The location could be determined via GPS, triangulation or by receiving data from a GPS or other device.

In one embodiment the controller is configured to send updated location data after the vehicle has moved, receive an updated route, and issue an instruction to move the vehicle based on the updated route. This allows the route to be updated even when the vehicle is moving.

According to an embodiment the controller is configured to monitor one or more local network parameters and report the one or more local network parameters to the network management system, the one or more local network parameters comprising one or more of the wireless coverage in the local area, the quality of service in the local area and the user demand in the local area. This allows the network management system to monitor the network to provide routes which take into account current and/or expected network demand.

According to a further embodiment monitoring one or more local network parameters comprises monitoring one or more of the number of wireless devices connected to the movable wireless access point and/or other access points in the network, the type of connection required by devices connected to the movable access point and/or other access points in the network, the number of wireless devices in range of the wireless module and/or other access points in the network and the amount of data being transferred through the wireless module and/or other access points in the network. This allows the movable wireless access device to obtain local network information based on wireless devices to which it is connected, or access points to which it is connected.

In a further embodiment, the wireless module is configured to connect wirelessly to other movable wireless access points and the movable wireless access point is configured to route data received from other movable wireless access points to the network management system. This allows the movable wireless access point to act as a router for other movable wireless access points so that they may conserve energy by not activating their direct connection to the internet.

According to an embodiment, the wireless module is configured to connect wirelessly to a further movable wireless access point; and connecting wirelessly to the internet comprises connecting to the internet via the wireless connection to the further movable wireless access point. This allows the movable wireless access point to conserve energy by using shorter range communications to nearby movable wireless access points to connect to the internet.

In one embodiment, the route is received when the vehicle is parked at a first position and route is limited to be within a predefined area surrounding the first position. This allows the vehicle to be moved even when parked to improve network performance. The predefined area ensures that the vehicle remains in the area where it was parked for when the user returns.

According to an aspect of the invention there is provided a method of managing a movable wireless access point configured to be mounted on a vehicle and comprising a wireless module configured to connect wirelessly to the internet and provide local wireless network coverage. The method comprises determining the location of the movable wireless access point and sending location data indicating the current location of the movable wireless access point to a network management system. The method further comprises receiving a route for the vehicle, the route directing the wireless access point towards one or more locations of demand for a wireless access point so that the movable wireless access point may provide wireless network coverage to the one or more locations of demand for at least part of the route, and issuing an instruction to move the vehicle based on the route.

According to a further aspect of the invention there is provided a system for providing a dynamic wireless network, the system comprising a plurality of movable wireless access points and a network management system, each movable wireless access point being configured to be carried by a vehicle. Each movable wireless access point comprising a wireless module configured to connect wirelessly to the internet, and provide local wireless network coverage, a position module configured to determine the location of the movable wireless access point, and a controller. The controller is configured to send location data indicating the current location of the movable wireless access point to the network management system, receive a route for the vehicle, and issue an instruction to move the vehicle based on the route. The network management system comprises a controller configured to monitor at least part of the network and determine one or more locations of demand for a wireless access point, receive the location data, and determine the route for the vehicle, the route being from the current location of the movable wireless access point and towards one of the one or more locations of demand so that the movable wireless access point may provide wireless network coverage to the location of demand for at least part of the route, and send the route to the movable wireless access point.

Embodiments aim to improve the current fixed base station wireless network system by allowing users to route data from their devices through either V2V or V2I networks. This is beneficial for several reasons:
a) The number of road vehicles and population density correlate positively in developed cities. This ensures there are more vehicles and therefore more mounted Access Points (APs) where there are people, thereby allowing for a more scalable network which by its very nature is able to deal with changing consumer and geographic demand.
b) The numbers of connected devices, internet usage and vehicle ownership all scale with real income, thus helping the network to self-scale with economic demand.
c) People living in more remote areas or buildings with poor network coverage will have better access to fast internet and mobile signal by using their vehicle as a wireless router and repeater station to connect to the main backbone wireless network (V2I). The connectivity of mobile devices (such as smart phones) often suffers due to the small batteries that are powering them. Vehicles (whether fuel or battery powered) have large energy reserves that are capable of powering larger and more powerful antennas in order to provide better local network coverage as well as connecting to the back bone wireless V2I network. In addition, by virtue of not having to be handheld, vehicles may carry much larger antennas than would otherwise be possible in mobile devices.

Since it is assumed that most vehicles in the future will be either semi or fully autonomous, embodiments of the present invention also allow for better routing and parking of these wirelessly equipped vehicles in order to provide better wireless network coverage and meet a Quality of Service (QoS) set by a governing body or network operator.

Three case scenarios of the proposed new MMWVNIS network infrastructure are described below.

1. A Rural User

A user with a compatible wireless device (such as a smartphone, laptop or tablet which is IEEE 802.11 compliant) located inside a building in a remote (rural) area of the county connects his devices to the user owned semi or fully autonomous vehicle in their driveway. The vehicle comprises a movable wireless access point, as described below. The user's devices connect seamlessly to his vehicle's 802.11 router as the client already has an account with the moving mobile wireless vehicle network infrastructure system (MMWVNIS) e.g. the NetCar Wi-Fi Hotspot Network Company. This allows the user to connect any of his devices to any vehicles equipped with the NetCar (MMWVNIS) system and route data through their Vehicle-to-Infrastructure (V2I) and Vehicle-to-Vehicle (V2V) systems in order to access the internet.

The user in this case can only route data through his vehicle as he lives in a remote rural area. Since there are few vehicles around, the vehicle connects directly to the nearest fixed mobile base station providing a fast wireless data link using a large antenna powered by the vehicle's large battery. The user is therefore able to move about inside his house or around his land with devices connected to the fast NetCar network. The user can route data such as media files, streaming videos and phone calls through the NetCar system. Furthermore, since the NetCar system incorporates a Network Attached Storage (NAS) system, the user is able to quickly access files he has saved there (the NAS, like the rest of the NetCar system, is installed in his semi or fully autonomous vehicle). Since the vehicle has at least some autonomous capabilities, it can move with the user in order to provide the best possible local wireless network coverage as well as quality of service. For example, if the user decides to move to a different part of the house or garden, the vehicle can move slightly from its parked space (whilst still on the driveway to the house) in order to locate itself to provide the best possible network coverage.

2. Vehicle Driving/Route Optimising

A semi or fully autonomous vehicle owned by either the passengers or a third party (such as a city taxi service) is driving between a start location (the location where the passengers entered the vehicle) and a user defined destination. The vehicle is equipped with the NetCar system and reports the start and end locations to a central operating support system (COSS) and database server using a V2I or through a V2V network of NetCar equipped vehicles. Of course, should neither of these wireless connections be available then the vehicle will have to rely on internally stored map data and/or the passenger controls. The COSS is a central server which manages the dynamic wireless network. The COSS replies with suggested routes for the user or vehicle to choose. The routes are selected on the basis of many parameters that are sent between the vehicle and the central server that runs the optimisation algorithm, some are listed below:
Current user location;
User required destination;
Local area road network map;
Number of passengers;
Level of vehicle autonomy (manual, semi or fully autonomous);
Vehicle condition;
Vehicle engine efficiency;
Vehicle energy supply (e.g. remaining fuel, battery life, hydrogen);
Loaded vehicle mass;
Current number of connected devices.

The COSS then finds information by searching an online database about the geographical area between the start and end locations. The information may include:
Current data network traffic based on locations within an urban area;
Current vehicle road traffic data based on location within an urban area;
Current (estimated) amount of users in different areas between the two points (start and end destination), this could be achieved from seeing how many people are currently connected to the NetCar system as well as looking at cellular base station data;
Current connected user data link requirements;
Historic data network traffic based on locations within an urban area;
Historic vehicle road traffic data based on location within an urban area;
Historic (estimated) amount of users in different areas between the two points (start and end destination).

Based upon this information a central server runs an optimisation algorithm to predict the demand in areas between the start and user selected end locations. It then tries to find optimal routes given various objectives, such as providing maximum network coverage by sending a vehicle equipped with a NetCar system to areas of the city with (predicted) high network demand but minimally sacrificing journey time compared to the fastest possible route. The central server then sends a set of possible routes and instructions for the semi or fully autonomous vehicle to follow once it or the user selects which route (out of the ones set from the central infrastructure) to take. If the vehicle is fully autonomous then the route (once selected) becomes a set of instructions for the vehicle to follow. If the vehicle is manual or semi-autonomous then it provides the driver with prompts (similar to a typical satellite navigation system) to direct him through the chosen route. If the route is particularly long, then it can be updated by the central controller. For example, if the vehicle is driving between points A and C (where A and C are the start and end locations respectively) then the vehicle might detour via point B in order to provide network coverage to that area as it is on its way to C.

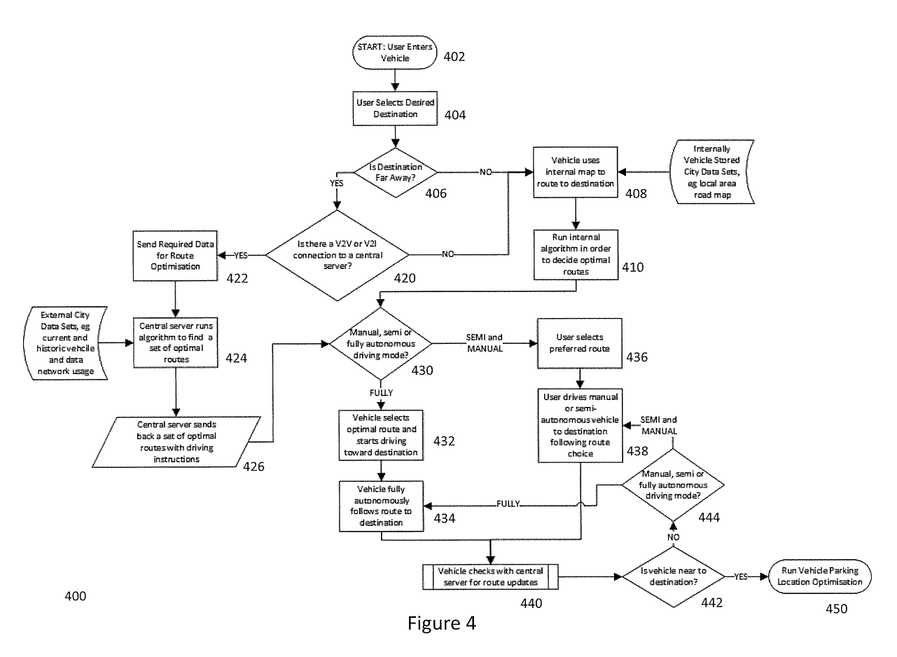

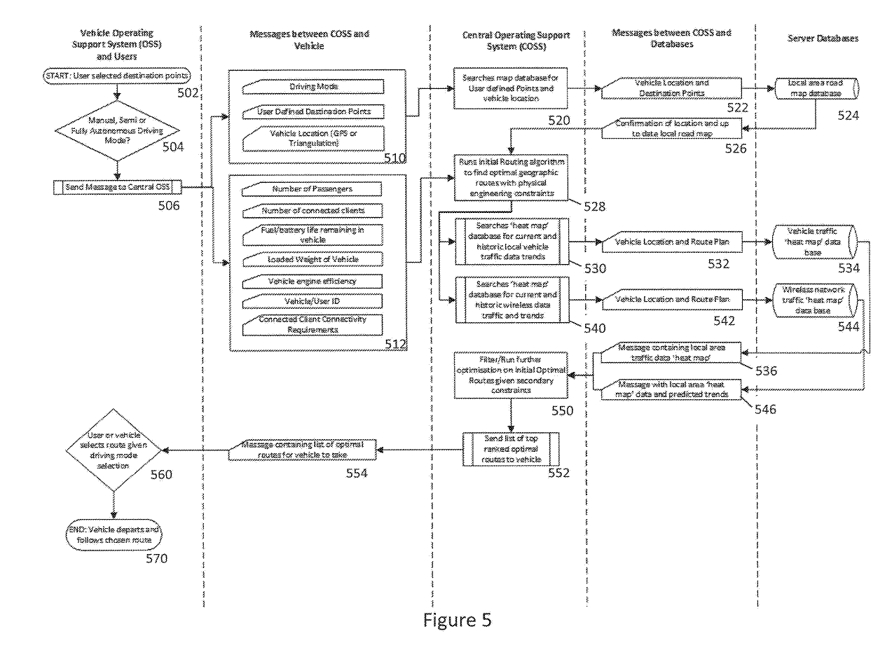

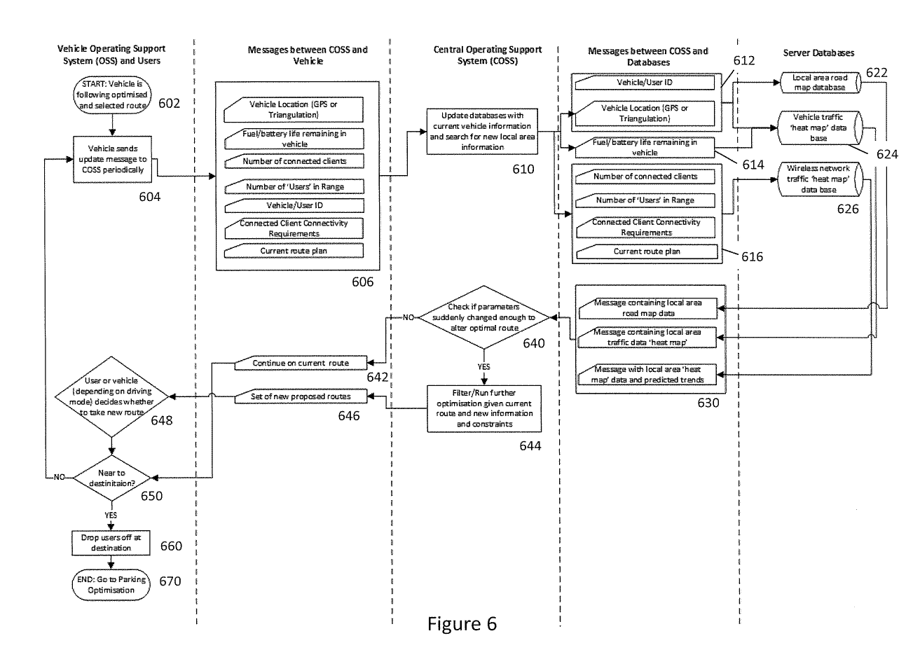

A flow chart further detailing the routing system is shown in FIG. 4. The communications required in order to achieve this level of vehicle routing is shown in a simplified message sequence diagram in FIG. 5 (start of the vehicle's journey) and FIG. 6 (whilst the vehicle is in motion along its route). These will be discussed in more detail below.

3. Parking Optimisation

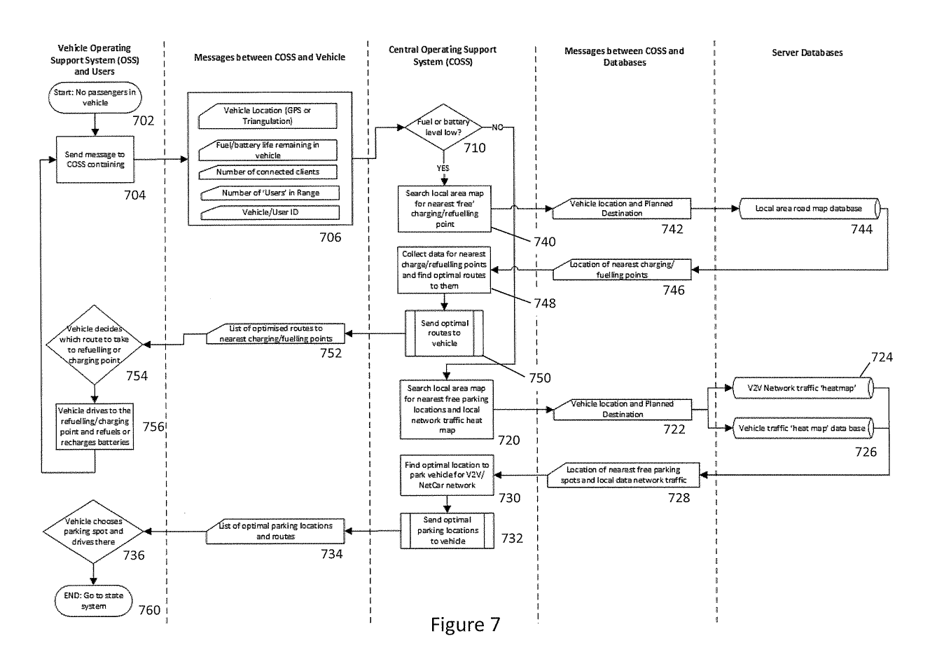

Users with devices that can connect to the NetCar network often move during the day with their devices. Furthermore vehicle locations change throughout the day to meet user demand. Thus, ‘gaps’ in the V2V network and NetCar access points may emerge (or change in number) throughout the day. In order to ensure that vehicles are within range of other vehicles when parked (to form a mesh V2V network in order to effectively route client data) and that access points are near to the client devices. The NetCar equipped parked vehicle may change its parking location without a user inside of it; however, this is only intended to be for small adjustments, such as moving a couple of vehicles up to 50 metres along a street to achieve better network links for the V2V network or moving a vehicle across a street to park on the other side to meet user demand. Users who own such vehicles will be able to place a limit on movement once they have left the vehicle. This is to add a layer of security as well as preventing vehicles from leaving the area should the owner want to use it again within ten or so minutes. A simplified message sequence diagram (FIG. 7) describes how this system would work as the vehicle approaches the user defined destination. This shall be described in more detail below.

Embodiments provide a Moving Mobile Wireless Vehicle Network System (MMWVNIS) which relies on the existence of a network of connected semi or fully autonomous vehicles; however, as has been discussed above, full automation of vehicles will not be possible unless they have a vehicle-to-vehicle (V2V) and vehicle-to-infrastructure (V2I) network to support their intelligent decision making process.

It is this network and the vehicles themselves that embodiments utilise along with a base system with certain detailed additions short range wireless (802.11) access points in order to provide a wireless network infrastructure. This is different to allowing passengers in the vehicle to connect to the internet via some long range (e.g. LTE type) wireless link.

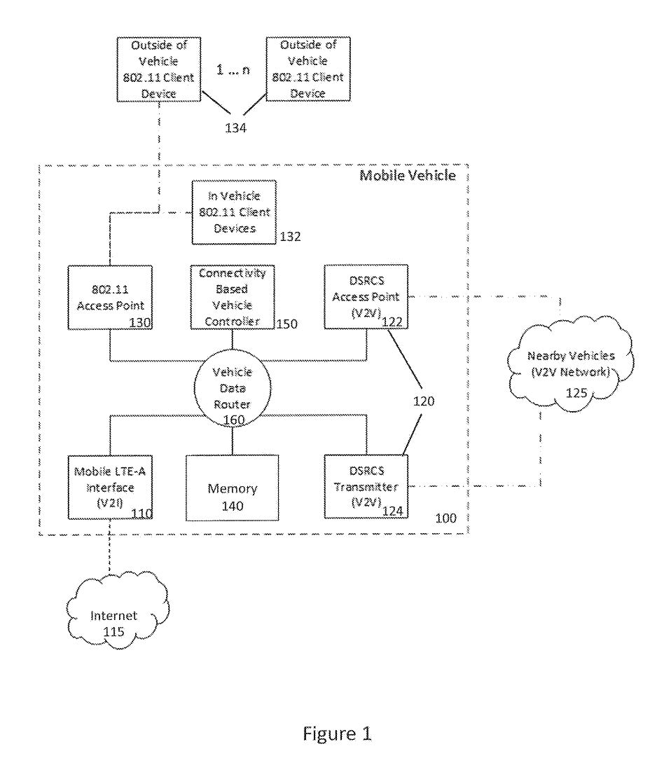

FIG. 1 shows a movable wireless access point 100 according to an embodiment. The movable wireless access point 100 is configured to be mounted on a vehicle, such as a car, or drone.

FIG. 1 is in the form of a system diagram depicting the MMWVNIS and highlighting key components and data links. The dashed box represents the boundaries of the vehicle. The solid lines represent internal wiring systems. Different dashed and dotted lines represent wireless links between different systems.

The movable wireless access point 100 comprises a first wireless module 110 for communicating wirelessly with the internet 115. The first wireless module 110 is configured to establish a long distance wireless connection with a wireless base station. This allows V2I wireless communication. In the present embodiment, the first wireless module 110 is a mobile LTE-A interface.

The movable wireless access point 100 comprises a second wireless module 120. The second wireless module 120 is configured to establish local wireless connections over a shorter distance than the first wireless module 110. In the present embodiment, the second wireless module 120 comprises a designated short-range communications (DSRCS) access point 122 and a DSRCS transmitter 124. This allows V2V communication between the movable wireless access point 100 and nearby vehicles 125 to exchange information relating to the operating states of the local movable wireless access points, local network parameters such as local user demand, and any other data required for semi or fully autonomous vehicle control.

The movable wireless access point 100 comprises a third wireless module 130. Like the second wireless module 120, the third wireless module 130 is configured to establish local wireless connections over a shorter distance than the first wireless module 110. The third wireless module 130 is configured to connect wirelessly to nearby devices, such as devices inside the vehicle 132 and any number of devices outside the vehicle 134. In the present embodiment, the third wireless module 130 is an 802.11 access point and is configured to connect to 802.11 devices (132, 134) such as laptops and smart phones using the 802.11 wireless protocol.

The movable wireless access point 100 comprises memory 140. The memory 140 stores computer readable code for instructing the movable wireless access point 100 to perform the functions described herein. The memory is also configured to store maps to allow the movable wireless access point 100 to determine routes for the vehicle when there is no internet connection or when the user's desired destination is within a predefined distance from the current location and therefore an optimised route is not required.

The movable wireless access point 100 comprises a controller 150. The controller 150 acts as an interface between the wireless networks and the vehicle control system. The controller 150 is configured to control the movable wireless access device 100 to manage wireless connections via the first 110, second 120 and third 130 wireless modules, to manage communication with the central operating support system (COSS) and to manage the selection of, and use of, routes received from the COSS. In addition, the controller 150 communicates with a GPS module in the vehicle to determine the location of the vehicle. In an alternative embodiment, the system does not communicate with a GPS module and instead the current location of the vehicle is determined via triangulation.

As shall be described in more detail later, the system can operate in manual, semi-autonomous or fully-autonomous modes. In the autonomous mode, the controller 150 issues instructions directly to the vehicle control system to instruct the vehicle to follow the route. In the manual or semi-autonomous modes, the controller 150 issues instructions to a user via the GPS module (e.g. via displaying the route or directions for the route) to instruct the user to drive the vehicle according to the route. In the semi-autonomous mode, the user controls the vehicle but the vehicle control system may also make minor adjustments (e.g. to slow the car due to upcoming traffic or to keep the car within a given lane).

The movable wireless access point 100 further comprises a vehicle data router 160. The vehicle data router 100 is configured to rout packets between the wireless modules 110, 120, 130. This allows packets to be routed via either a V2V or V2I network in order to provide internet access to both the vehicle's internal driving systems as well as the compatible user client devices 132, 134.

By utilising the embodiment of FIG. 1, multiple vehicles would be able to communicate with clients, other similarly equipped vehicles, and fixed wireless infrastructure base stations to then form a MMWVNIS.

Much of the hardware of FIG. 1 will also need to be present in the vehicle in order to achieve full autonomy. Accordingly, autonomous vehicles may be simply and effectively adapted in order to form a dynamically moving mobile wireless network.

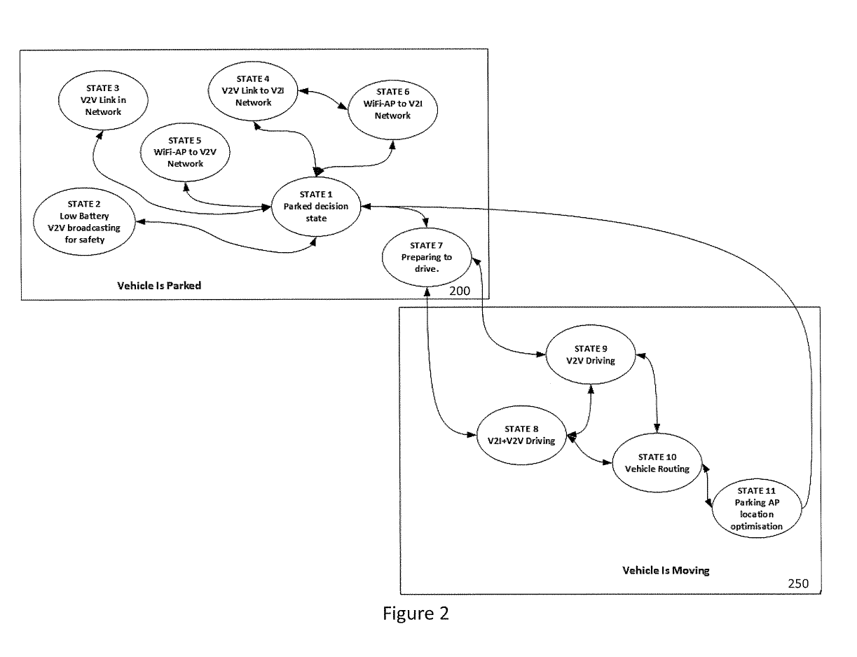

FIG. 2 shows the various states in which a movable wireless access point may operate. Each movable wireless access point is able to choose its own state based upon local as well as global information provided by the central controlling infrastructure or other movable wireless access points to which it is connected. The figure shows how these different states interact with each other and how a vehicle may change from being parked to moving and vice versa. The various states are described in Table 1.

TABLE 1
The various available states for a movable wireless access point.

| | Vehicle | State | |
|---|---|---|---|
| STATE | Mobility | Type | State Description |
| 1 | Parked | Decision | Communicate with nearby vehicles and central infrastructure. |
| | | state | Establish current local network user demand and run algorithm |
| | | | to decide next state. |
| 2 | Parked | Low battery/ | Off mode to conserve battery. Wireless modules are turned |
| | | no demand | off apart from safety V2V to avoid collisions with oncoming |
| | | | traffic on road. Poll other vehicles for updates on network |
| | | | state and if there is need to turn on APs. |
| 3 | Parked | V2V link | Vehicle acts as (V2V only) link in a V2V local network to |
| | | | route client and machine data. |
| 4 | Parked | V2V link | Vehicle acts as a link in V2V network but routes outgoing |
| | | to V2I | data to fixed main network infrastructure V2I. |
| 5 | Parked | AP-V2V | Client 802.11 AP routes data through vehicle V2V network |
| 6 | Parked | AP-V2I | Client 802.11 AP routes data through V2I network (e.g. |
| | | | when in remote areas, acts as a repeater station) |
| 7 | Parked | Preparing | User enters vehicle, inputs destination, selects manual, |
| | | to Drive | semi, fully autonomous drive mode. Based on network |
| | | | availability vehicle selects driving and routing method. |
| 8 | Parked/ | V2I driving | V2I and V2V wireless links are possible, vehicle |
| | Driving | (vehicle | communicates with both to understand best route given |
| | | algorithm 1) | vehicle and data traffic conditions. V2I does the routing |
| | | | algorithm and sends data to vehicle to follow or supply as |
| | | | instructions to the driver. |
| 9 | Parked/ | V2V driving | V2I is not accessible. Uses internally stored map and V2V |
| | Driving | (vehicle | info in order to work out optimal route to destination. By |
| | | algorithm 2) | avoiding traffic and providing as much wireless network |
| | | | coverage as possible. |
| 10 | Driving | Driving | Poll V2V and V2I in order to get latest vehicle and data |
| | | | traffic updates, maybe change route slightly if needed. Turn |
| | | | off and on communication systems when needed. |
| 11 | Driving | To Park | Run parking optimisation algorithm in order to select spot if |
| | | (near end | near to destination (e.g. within 50 m). If possible choose |
| | | of route) | parking spot where best network coverage can be provided, |
| | | | e.g. near a junction. Once parked, move to the decision |
| | | | state (state 1). |

Rectangles are used to denote whether the states are occurring in a moving or stationary (parked) vehicle. States 1-7 are states for when the vehicle is parked (parked states, 200). States 8 and 9 are both parked states and states for when the vehicle is moving (driving states). States 10 and 11 are driving states 250.

State 1 is a decision state. In this state, the vehicle is parked and the movable wireless access point determines how it will communicate with any surrounding devices. The movable wireless access point communicates with nearby vehicles (V2V) and central infrastructure (V2I) to establish the current local network user demand. The movable wireless access point may also utilise the number of devices which attempt to connect to it via 802.11 wireless connections. Based on the local network user demand, and on the current energy reserves available for the device (e.g. battery life), the movable wireless access point determines which parked state to operate under.

State 2 is activated if the energy reserves (such as battery power) are below a given threshold or if there is no local demand for wireless access. In this mode, the first and third wireless modules are turned off to conserve energy. Functionality of the second wireless module will be limited to that required for safety, for instance, V2V transmissions to prevent road users from colliding with the parked vehicle. The system will also intermittently connect with other vehicles to determine the local network demand for the movable wireless access point. If the demand is greater than a threshold then the system can transition to another state to activate the wireless modules to service the increased network demand. This threshold may vary based on the energy reserves, for instance, the required demand may need to be higher to turn on wireless communications if the energy reserves are lower. Moreover, at a certain energy level such wireless communication may be completely prohibited.

State 3 establishes V2V communication only. This allows client and other data to be routed through the local V2V network. If a large number of movable wireless access points are located close to one another, there is little need for all of them to connect to the local infrastructure via V2I communication. As V2I communication is of a longer range than V2V, it uses more energy. Accordingly, to reduce the overall energy consumption, a movable wireless access point may connect to the internet via the V2I connection of another movable wireless access point (operating in state 4). State 3 is chosen if the energy reserves and the local network demand for the wireless access point are above respective thresholds and if another movable wireless access point in the local network is operating as a router to the internet (operating in state 4).

State 4 establishes both V2V and V2I communication. The movable wireless access point connects to the internet via a wireless base station and acts as a router for nearby movable wireless access points to enable them to access the internet. State 4 is enabled if no other V2I connection is available or if instructed to do so by the COSS (for instance, due to a more favourable position providing better reception for the movable wireless access point than that of the current V2I connection).

State 5 establishes wireless connections with local devices and routes the data packets through the V2V network. Accordingly, the second and third wireless modules are activated but the first wireless module is not. This state may be activated if local network demand for the wireless access point is high but another local wireless access point is operating in state 4 and is therefore able to relay communications via V2I.

State 6 routes data received from local devices directly to the internet (and vice versa) via V2I communication. In this mode, the system acts as a repeater station, forwarding data from the devices on to the internet and vice versa. This state is activated if no other movable wireless access points are available and transmitting over V2I, for instance, in remote areas where no other vehicles are present. Alternatively, this state is activated when the conditions for state 4 have been satisfied and the data from a local wireless device is required to be transferred over the internet. The movable wireless access point may quickly transition between states 4 and 6 to manage the flow of data through V2I communication and local wireless devices or local movable wireless access points (V2V). In an alternative embodiment, the movable wireless access point is configured to operate in a state where V2I and V2V are possible, as well as wireless connection to local wireless devices.

State 7 is activated when a user enters the vehicle and selects a destination and drive mode (manual, semi or fully autonomous) via a user interface of the movable wireless access point. The destination may be selected via a GPS module connected to or inbult into the movable wireless access point. Alternatively, state 7 may be activated when an instruction is received from the central server for the vehicle to move to a different parked position to improve network service. This feature is only applicable to movable wireless access points connected to autonomous vehicles.

State 8 shows how the movable wireless access point may may communicate with the COSS to determine the best routes based on network demand. The movable wireless access point communicates the desired destination and the current location of the vehicle (determined from the GPS module or via triangulation) to the COSS via V2I (or via V2V where another movable wireless access point is acting as a router to the COSS). As shall be described below, the COSS determines a number of possible routes to the destination based on the network demand. These routes direct the vehicle towards areas of demand for a wireless access point so that these areas may be serviced by the movable wireless access point to improve network performance. The user may then select the route which they wish to follow. Once selected, the route is communicated either to the vehicle control system (in autonomous mode) to instruct the vehicle to follow the route, or to the GPS (in manual or semi-autonomous modes) to instruct the user to follow the route.

State 9 is activated if no V2I is possible, for instance, if no base station is in range. The system uses an internally stored map and V2V information to determine the a route to the destination before instructing the vehicle control system or the user to follow the route. Each movable wireless access point reports its local network user demand to the other movable wireless access points on the V2V network. Based on the limited information of the local V2V network, the wireless access point can determine a route to the destination which passes local levels of demand for wireless access points. Should the movable wireless access point gain V2I communication, it may contact the COSS to obtain an updated route. In most cases, this will be improved relative to the initial route as the COSS has more accurate knowledge of the areas of demand for wireless access points.

In state 10 the vehicle is moving to the desination. Periodic vehicle and data traffic updates are obtained via V2V and V2I. The position of the vehicle is transmitted to the COSS which may issue a new route based on changes in vehicle or data traffic. Alternatively, the movable wireless access point may determine an improved route based on the local data available over the V2V network. The updated route is then communicated to either the user or the vehicle control system, dependent on the driving mode. As the vehicle is travelling, the various wireless modules may be turned on and off depending on the local network demands.

State 11, the parking state, is activated when the vehicle comes to within a predefined distance of the destination. The controller runs a parking optimisation algorithm to select a location to stope. The location should be near to the destination but should also place the movable wireless access point in a position to provide good network coverage. This may be a position where V2I connection is strong or where network demand is high. The final destination is therefore based on the user's desired destination, the network demand and the V2I network coverage. Once the vehicle has stopped, the system returns to state 1 to determine which parking state to use.

It should be noted that, whilst FIG. 2 shows few direct transitions between states 2-6), in some embodiments, these transitions are possible without requiring the system to move to state 1.

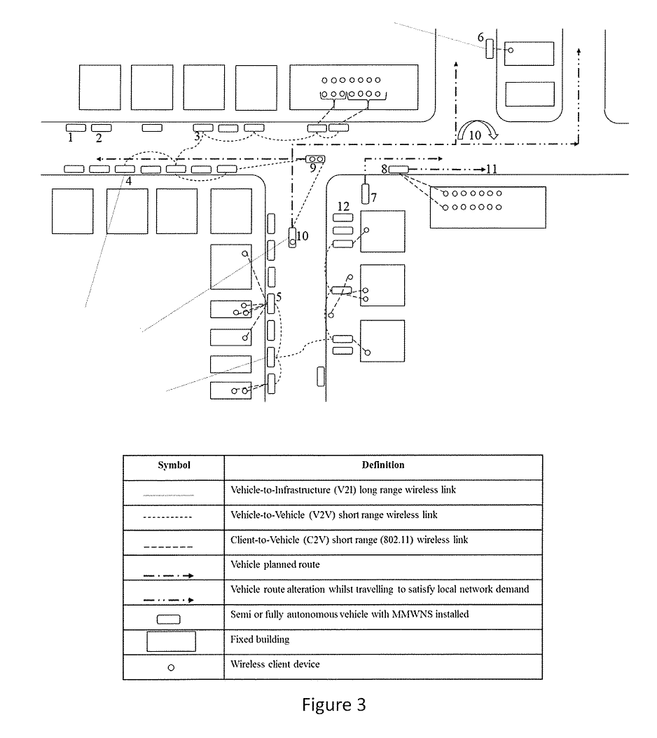

FIG. 3 shows a moving mobile wireless vehicle network infrastructure system (MMWVNIS) according to an embodiment. This highlights some structural differences of the MMWVNIS compared to a fixed base station network infrastructure. Each vehicle (represented as a small rectangle) comprises the movable wireless access point system of FIG. 1. Each vehicle is able to decide which state it is in given local as well as infrastructure level knowledge. The state for each vehicle is displayed in FIG. 1 alongside the vehicle.

Compared to a fixed base station infrastructure, the MMWVNIS has vehicles moving and changing location even without passengers in order to provide optimal network coverage and meet quality of service requirements to clients in range, for example, shown by vehicles in states 7, 9 and 11. Furthermore the network is self-organising to an extent. For example, in areas where there are lots of parked vehicles, there is no need for them all to have their MMWVNIS turned on in order to provide a wireless network for the local population.

Accordingly, unlike traditional networks, the ‘nodes’ are mounted on vehicles which are directed either a central server or individual vehicles. This allows for a dynamically changing and scaled network.

As mentioned above, the parked vehicles may move even without passengers. This allows the movable wireless access points to improve local network service as demand, quality of service (QoS) and coverage changes. A user may set a maximum distance which the vehicle may travel once parked, or may set a time by which the vehicle should return. In addition, the user may call the vehicle back by issuing a command to return via the internet (such as via a mobile app).

The MMWVNIS is different from traditional wireless hotspots for the following reasons:
a) It allows users both inside and outside of the vehicle to connect to the Internet. This includes users working or living in buildings connecting to vehicles outside of the building with or without passengers inside of them.
b) It can route user data via either it's long range wireless backbone link (V2I) or via its V2V system, should it be beneficial in terms of QoS and energy efficiency (e.g. reducing vehicle battery or fuel consumption).
c) It is not designed as an emergency system, rather it is a wireless network infrastructure designed to closely scale with demand and regulate itself through some of its self-organising features or through a more ‘global’ optimum detailed by central servers controlling the transportation and network systems of future urban areas.
d) The network is not fixed. Instead each of the access points on the vehicles will allow data to be transferred/routed even when in motion, thus there is an important physical vehicle routing and parking location optimisation system that further improves the network performance to meet QoS or network coverage (NC) requirements set by a network operator.

FIG. 3 gives real world examples of how multiples of such equipped vehicles could work together to form this MMWVNIS. The figure highlights the different states (shown by the large numbers in the figure) vehicles can be in and shows examples of how they benefit the end users. FIG. 3 in combination with FIG. 2 and Table 1 highlight how the MMWVNIS operates. Each state number in FIG. 3 refers to a different state described and defined in Table 1. As the network demands change, so do the states in which the vehicles are operating. For example, due to low network demand in the top left corner of FIG. 3, a number of vehicles have their communication systems turned off to conserve energy. Whereas, to the right of FIG. 3 (e.g. further down the street) there is an office building with many clients (represented by small circles) with few access points. The central infrastructure system or vehicles driving by this location will be able to sense that there are a lot of clients there and might re-route vehicles on the move such as the vehicle in state 10 (centre of diagram) to change route in order to pass by the office. Furthermore, vehicles that are parked just out of range of the office will move themselves (vehicles in states 7, 8 and 11) to be nearer to the office to supply the area of high demand.

Accordingly, embodiments control the physical location and movement of the wireless access points mounted on vehicles in order to provide the network coverage and quality of service required.

A MMWVNIS has the following advantages over traditional fixed wireless infrastructure:
a) It is much more scalable. As discussed above, vehicle ownership and number of connected devices both correlate positively with increased population densities and real income. This allows for more access vehicles and therefore access points to be present in areas of high user demand.
b) A moving network allows for better demand response. Since the access points are mounted on vehicles, as users move around a city using their vehicle the access point adapts to changes in demand.
c) The network performance and coverage can be further improved by routing vehicles in such a manner to provide more access points to areas of cities with poor coverage.
d) Vehicles have large batteries and can support larger antennae. They are therefore better able to connect to distant network infrastructure base stations and provide fast internet connections to people living in more rural areas.

FIG. 4 shows a flow chart of the process of determining a route and following the route towards a destination. This summarises the decisions and processes required for a vehicle (that is part of a MMWVNIS) and a passenger in order to move from one location to another.

The method 400 begins with the user entering the vehicle 402. The user then selects the desired destination 404. The movable wireless access point determines whether the destination is greater than a predefined distance away 406.

If the destination is not far away, for example, within a mile of the current location, then there is little need to run full route optimisation. The system therefore avoids contacting the central server to route the vehicle based on network demand. A locally stored map is accessed from memory 408. An internal algorithm is run to determine a selection of optimal routes to the destination based on the map 410.

If the destination is far away then it is determined whether a V2V or a V2I connection to the central server is available 420. If not, then the vehicle goes to step 408 to determine a route from the locally stored maps. If the central server is contactable, then the current location of the vehicle and the desired destination are sent to the central server 422. The central server then determines a set of routes which travel from the current location to the destination and which pass one or more areas of demand for a wireless access point 424. This determination can make use of current and historical vehicle usage and current and historical network usage. Based on rules stored at the server the routes pass areas of expected or current demand and avoid areas of expected or current traffic, whilst also keeping the travel distance to the destination as low as possible. These rules can be varied to either provide faster travel or improved network performance based either on the network provider's specifications or inputs from the user. Once determined, the set of routes are sent to the movable wireless access point 426.

Once the set of routes have been determined (either centrally or locally, i.e. after steps 426 or 410), it is then determined if the vehicle is operating in manual or semi or fully autonomous driving mode 430. If the vehicle is operating in fully autonomous driving mode then the controller selects a preferred route and transmits this to the vehicle control system to instruct the vehicle control system to follow the route 432. The vehicle then follows the route autonomously towards the destination 434.

If the vehicle is in manual or semi-autonomous driving mode then the user selects the preferred route from the set of routes provided 436. The route is then displayed to the user, for instance, via directions on a GPS, and the user drives towards the destination following the route 438.

As the vehicle travels towards the destination, the system periodically checks with the central server to determine if the route should be updated 440 and updates the route accordingly if so. This checking involves transmitting the current position to the central server. If the route is to be changed then a new set of one or more routes will be sent from the server to the vehicle. Once a new route has been selected, the controller instructs the vehicle control system to follow the new route.

After step 440 it is then checked whether the vehicle is within a predefined distance of the destination 442. If not, then it is determined whether the vehicle is in manual, fully or semi-autonomous driving mode 444. If in fully autonomous driving mode then the method loops back to 434 to continue autonomous driving towards the destination. If the vehicle is in manual or semi-autonomous driving mode then the method loops back to step 438 and the driver continues to follow the route towards the destination.

If the vehicle is close to the destination then vehicle parking location optimisation is run to determine a final destination which balances network needs with the needs of the user 450 before the vehicle travels to the final destination.

FIGS. 5, 6 and 7 show the information and message sequences between a vehicle and a central server as a vehicle (that is part of a MMWVNIS) moves from one location to a desired destination. Rectangular boxes represent processes (or sub-processes) being carried out, the five sided shaped boxes represent messages send between parties, diamond boxes represent decisions.

FIG. 5 shows the message sequence between a movable wireless access point and a central server for an initial start phase of a journey. This is when a passenger enters a vehicle, inputs the required destination (with added intermediate destinations, if desired) and a route is determined.

The process starts with the user selecting a destination 502 at the movable wireless access point. Intermediate destinations may also be input. These may be input via a user interface or via a GPS system connected to the movable wireless access point. The movable wireless access point then determines if the vehicle is in manual, semi or fully autonomous driving mode 504.

A message is then sent to a central server (the central operating support system) 506. This message contains a first part 510 and a second part 512. The first part 510 contains information detailing the driving mode, the one or more user defined destinations and the current vehicle location. The vehicle location may be determined based on a GPS module located in the vehicle or via triangulation. The second part 512 contains information relating to the number of passengers, the number of devices connected locally to the movable wireless access point, the energy reserves of the vehicle, the loaded weight of the vehicle, the engine efficiency of the vehicle, information identifying the vehicle and/or user and the connectivity requirements of the devices connected to the movable wireless access point.

The first part of the message 510 is used by the central server to locate the current location of the vehicle and the set of destinations using a map database 520. The map database may be stored at server databases either local to the central server or accessible to the server via the internet. The vehicle location and one or more destinations are sent to the server databases 522. The server databases then locate the relevant local area map database based on the vehicle location and one or more destinations 524. The relevant map or set of maps which cover the vehicle location and destination(s) are sent to the central server from the server databases along with a confirmation of the vehicle location 526.

The central server then uses the contents of the second part of the message 512 and the data received from the server databases to determine an initial set of routes based on the physical engineering constraints of the vehicle 528 (energy reserves, load, distance etc.). The routes begin at the current vehicle location and finish at the destination, passing through any intermediate destinations if these have been input. If energy reserves are low (for instance, low fuel), then the vehicle may be routed via a refuelling station.

The central server searches for current and historical traffic data 530 and current and historical network usage data 540 to help inform the route creation process. The searches 530, 540 are run in parallel. The central server sends the current vehicle location and initial route to the server databases 532, 542. Based on this information, the server databases locate the relevant vehicle and network traffic heat map databases 534, 544. The server databases then return the vehicle and network traffic data heat maps and any predicted trends in vehicle traffic and network usage to the central server 536, 546.

Based on the vehicle traffic and network traffic data, the central server adapts the initial routes to take into account the new data. The central server determines areas of demand for wireless access points based on the network information. This may be based on a required quality of service, coverage or current or historic data usage. This allows the central server to determine routes which pass from the vehicle location to the destination via any intermediate destinations and which also pass areas of demand for wireless access points to allow the movable wireless access point to provide network coverage to at least part of the relevant areas of current or predicted demand for at least part of the route. The routes are also determined to avoid any areas of current or predicted high traffic. The determined routes will be based on the relevant weighting applied to each set of criteria (vehicle traffic, network demand, etc.).

The central server then sends 552 a message 554 containing the set of routes determined in step 552 to the movable wireless access point. The user or vehicle (depending on the driving mode) then selects one of the routes 560. The routes are then output depending on the driving mode in order for the vehicle to follow the chosen route 570.

As mentioned above, in fully autonomous driving mode the route is output to the vehicle control system as an instruction to follow the route. The vehicle control system then drives the vehicle according to the route. In manual or semi-autonomous driving mode, the route is output to a GPS system or other display means so that the route may be displayed (either fully or in the form of directions) to the user to allow the user to drive the vehicle according to the route.

FIG. 6 shows the message sequence between a movable wireless access point and a central server as the movable wireless access point is travelling. This continues the message sequence of FIG. 5 by detailing the exchange of information required for when the vehicle is in motion and travelling towards the destination.

The process continues from FIG. 5 as the vehicle follows the selected route 602. The movable wireless access point periodically sends update messages to the central server 604. The update message 606 contains data indicating the vehicle location (obtained via GPS or triangulation), the remaining energy reserves (fuel or battery life), the number of devices wirelessly connected to the movable wireless access point, the number of devices in range of the movable wireless access point, information identifying the vehicle and/or user, the connectivity requirements of the devices connected to the movable wireless access point and the current route being followed.

Based on the update message, the central server updates server databases and searches for new local area information 610. First 612, second 614 and third 616 messages are sent from the central server to the server databases. The first message 612 contains the information identifying the vehicle and/or user and the current vehicle location. The second message 614 contains information specifying the energy reserves of the vehicle. The third message 616 contains information specifying the number of devices connected to the movable wireless access point, the number of devices in range of the movable wireless access point, the connectivity requirements of the connected devices and the current route being followed.

Based on the first message 612, the server databases locate the relevant local map database 622. Based on the first 612 and second 614 messages the server databases locate the relevant vehicle traffic database 624. Based on the third message 616 the server databases locate the relevant network usage database 626.

The server databases then send a return message 630 to the central server. This return message 630 contains the local area map, the local area vehicle traffic data and the local area network data. Based on this return message 630 the central server determines if the parameters have changed enough to alter the route 640. This may be if there has been greater than a predefined change in the vehicle or network data either globally or along the current route.

If the parameters have not changed sufficiently to justify a new route, a message is sent to the movable wireless access point to instruct it to continue on the current route 642.

If the parameters have changed sufficiently to require an updated route then a new set of routes are determined based on the new data 644. The new routes may be calculated from scratch, as shown in the process of FIG. 5, or may be based at least partially on the current route being followed. The new routes are sent to the movable wireless access point 646. Depending on the driving mode, the user or the movable wireless access point then selects one of the new routes 648 and instructs the vehicle to travel along the new route to the destination.

The movable wireless access point then determines whether the vehicle is within a predetermined distance of the destination 650. If not, then the method loops back to step 604 to send a further update message and determine if a new route should be taken. If the vehicle is close to the destination then the vehicle delivers the user(s) to the destination 660 before beginning parking optimisation 670 (FIG. 7).

FIG. 7 shows the message sequence between a movable wireless access point and a central server for the end of a journey. This concludes the message sequence of FIGS. 5 and 6 by detailing the sequence of information transfer required for when the vehicle has dropped off its passengers and needs to determine where to park and (if necessary) refuel/recharge. It shows the process of determining a final destination in order to provide an improved a MMWVNIS service if required in the destination area. Naturally, this method is only applicable to movable wireless access points connected to autonomous vehicles.

The process follows FIG. 6 and begins after the passengers have exited the vehicle at their destination 702. At this point, the movable wireless access point sends a message to the central server 704. The message 706 contains the current vehicle location (determined either by GPS or triangulation), the energy reserves of the vehicle (fuel and/or battery life), the number of devices wirelessly connected to the movable wireless access point, the number of devices in range of the movable wireless access point, and information identifying the vehicle and/or the user of the vehicle.

Based on the message, the central server determines whether the energy reserves are below a threshold 710. If not, then the central server searches the local area map and local network and vehicle traffic data 720 so that a parking space may be determined. If the energy reserves are below the threshold then the central server searches for a local charging or refuelling point (whichever is required) for the vehicle 740.

In searching for the local area map and network and vehicle traffic data, the central server sends the vehicle location and planned destination to the server databases 722. The server databases use this information to select the local network traffic data 724 and the local vehicle traffic data 726. The sever databases send the location of free parking spots in the area and the local network traffic data to the central server. The location of free parking spots in the area may be determined by the sever databases based on the local vehicle traffic data or may be contained in the local vehicle traffic data which may be sent to the central server which subsequently determines the location of the free parking spaces. Based on the information sent by the server databases, the central server determines a number of possible final destinations (parking spaces) for the vehicle according to the local network needs and the needs of the user 730. For instance, the user may set a maximum distance from the user drop off point that the vehicle may travel in order to satisfy network requirements such as improving wireless coverage or servicing local areas of high network demand. The list of possible final destinations and routes to the final destinations is sent 732 in a message 734 to the movable wireless access point. The movable wireless access point then selects a route and directs the vehicle control system to autonomously drive the vehicle according to the route 736. Once parked, the movable wireless access point enters state 1 to determine which parking state to operate under 760.

If necessary, the movable wireless access point may instruct the vehicle to move to a new parking space upon receipt of an instruction (and route) from the central server and/or upon receipt of local network data from the server or local access points which indicates that a new parking position would be desirable.

As mentioned above, if the energy reserves are low, then the central server searches for a nearby refuelling/recharging station 740. The central server sends a message containing the vehicle location and planned destination to the server databases 742. The server databases then locate the local area map 744 and send the location of the nearest charging/refuelling points to the central server 746. Based on this information, the central server determines the a number of routes to the charging/refuelling points 748 and sends the routes to the movable wireless access point 750 in a message 752. The movable wireless access point then determines which route to take 754 and instructs the vehicle control system to autonomously drive the vehicle to the recharging/refuelling point according to the route 756 Once the vehicle has reached the recharging/refuelling point (and been recharged/refuelled as required), the method loops back to step 704 to send a message to the central server to find a route to a parking space.

As discussed above, FIGS. 5-7 are connected (simplified) message sequence diagrams which relate to a single, joined message sequence. They are shown as separate figures in order to aid comprehension.

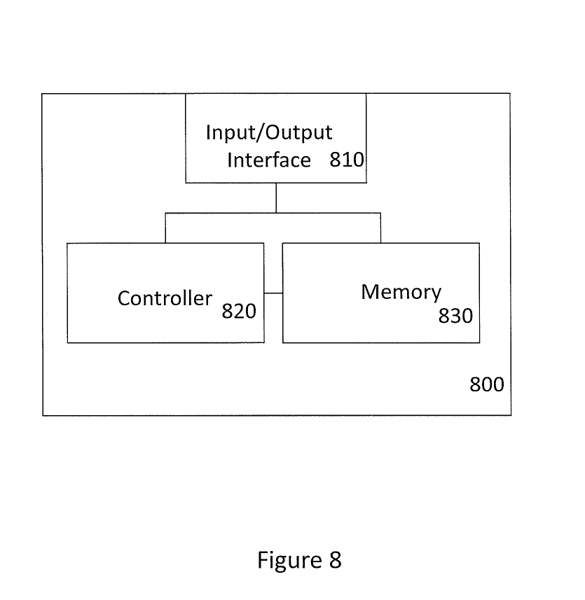

FIG. 8 shows a central server 800 configured monitor network performance and determine routes for movable wireless access points accordingly. The server 800 comprises an input/output interface 810, a controller 820 and memory 830.

The input/output interface 810 is configured to receive data from movable wireless access points and transmit routes to the mobile wireless access points. As discussed above, the data from the movable wireless access points comprises vehicle location data and destination data. The input/output interface 810 is also configured to receive data (such as maps and vehicle and network traffic data) from external servers.

The controller 820 is configured to monitor network parameters, as reported by movable wireless access points and/or by other means such as traditional stationary access points and determine areas of high network usage. The network parameters include data usage in an area, the number of wireless devices connected across an area, the ratio of the number of wireless devices in an area to the number of available access points and the ratio of the amount of data used in an area to the total available bandwidth in the area. Historical network parameters may be stored along with the time the parameters were recorded to allow predictions of future network events. For instance, a period of high data usage in an area may be associated with a particular time of day, time in the week, time in the month or time in the year. The controller 820 may therefore be able to predict high usage for a corresponding future time based on the historical network data.

The controller 820 is also configured to monitor traffic via vehicle usage data, either as reported by an external entity, such as a government body, or as reported by movable wireless access points or other V2V and V2I functional vehicles.

The controller 820 is configured to determine routes for a movable wireless access point, the routes starting from the current location of the movable wireless access point, ending at the destination and passing near to or through one or more areas or locations of current or predicted demand for wireless access points so that the movable wireless access point can provide wireless coverage to the location or at least part of the area of demand. In one embodiment, the controller 820 determines routes which also aim to avoid traffic based on vehicle usage data.

The memory 830 stores computer readable code instructing the controller 820 to perform the functions as discussed in the present application. The memory 830 also stores vehicle and network usage data to be used in the determination of routes. In one embodiment, the memory also stores maps for use in the determination of routes. In another embodiment, the central server 800 is configured to access maps located in an external server.

Whilst the above embodiments relate to traditional autonomous vehicles such as cars, these embodiments may be applied to movable wireless access points which are configured to be carried by any vehicle. Such vehicles include land based vehicles (such as cars and motorbikes), water based vehicles (such as boats and ships) and air based vehicles (such as helicopters, planes and drones). Such vehicles may be manual, autonomous or semi-autonomous and therefore may be unmanned. Equally they may be passenger vehicles, vehicles for transporting goods, or may be vehicles designed primarily for carrying movable wireless access points to improve network performance.

According to any and all embodiments explained above a network with movable wireless access points is implemented to provide improved wireless performance. While certain embodiments have been described, these embodiments have been presented by way of example only, and are not intended to limit the scope of the inventions. Indeed, the novel methods and devices described herein may be embodied in a variety of other forms; furthermore, various omissions, substitutions and changes in the form of the methods and devices described herein may be made without departing from the spirit of the inventions. The accompanying claims and their equivalents are intended to cover such forms or modifications as would fall within the scope and spirit of the inventions.

1. A method of managing a dynamic wireless network comprising at least one movable wireless access point configured to be carried by a vehicle, the method comprising:
monitoring at least part of the network and determining one or more locations of demand for a wireless access point;
receiving location data indicating the current location of the movable wireless access point; and
determining a route for the vehicle, the route being from the current location of the movable wireless access point and towards one of the one or more locations of demand so that the movable wireless access point may provide wireless network coverage to the location of demand for at least part of the route.

2. A method according to claim 1 wherein monitoring at least part of the network comprises monitoring one or more of coverage, quality of service and user demand for at least part of the network.

3. A method according to claim 1 wherein the one or more locations of demand are determined based on historical and/or current network parameters which comprise one or more of the amount of data used in an area, the number of wireless devices in an area, the ratio of the number of wireless devices in the area to the number of access points in the area and the ratio of the amount of data used in the area to the total available bandwidth in the area.

4. A method according to according to claim 1 wherein:
the method further comprises receiving data indicating a desired destination for the movable wireless access point; and
determining the route comprises determining a route from the current location of the movable wireless access point to the desired destination and which approaches or passes the location of demand to allow the movable wireless access point to provide wireless network coverage to the location of demand for at least part of the route.

5. A method according to claim 4 further comprising:
receiving an updated location of the movable wireless access point;
determining whether the updated location is within a predefined distance from the desired destination; and
determining an updated destination and a route to the updated destination, wherein the updated destination and route are determined based local demand for a wireless access point.

6. A method according to claim 1 further comprising monitoring traffic data to determine one or more areas of increased traffic density and wherein the route is determined based on the traffic data to avoid at least one of the one or more areas of increased traffic density.

7. A method according to claim 1, the method further comprising, subsequent to sending the route:
continuing to monitor at least part of the network and determining one or more updated locations of demand for a wireless access point;
receiving an updated location of the movable wireless access point;
determining an updated route for the movable wireless access point based on the updated location and one of the one or more updated locations of demand.

8. A method according to claim 1 further comprising receiving energy reserve data indicating the energy reserves of the vehicle and wherein, when the energy reserves of the vehicle are below a predefined value, the route is determined to pass or end at a refuelling or recharging station.

9. A method according to claim 1 further comprising:
receiving network usage data from a number of movable wireless access points; and
based on the network usage data, issuing instructions to one or more movable wireless access points to at least partially disable wireless communication to save energy.

10. A device for managing a dynamic wireless network comprising at least one movable wireless access point configured to be mounted on vehicle, the device comprising a controller configured to:
receive data relating to data usage across at least part of the network;
monitor the network and determine one or more locations of demand for a wireless access point;
receive location data indicating the current location of the movable wireless access point; and
determine a route for the vehicle, the route being from the current location of the movable wireless access point and towards one of the one or more locations of demand so that the movable wireless access point may provide wireless network coverage to the location of demand for at least part of the route,

11. A movable wireless access point configured to be mounted on a vehicle and comprising:
a wireless module configured to:
connect wirelessly to the internet; and
provide local wireless network coverage;
a position module configured to determine the location of the movable wireless access point; and
a controller configured to:
send location data indicating the current location of the movable wireless access point to a network management system;
receive a route for the vehicle, the route directing the wireless access point towards one or more locations of demand for a wireless access point so that the movable wireless access point may provide wireless network coverage to the one or more locations of demand for at least part of the route; and
issue an instruction to move the vehicle based on the route.

12. A movable wireless access point according to claim 11 wherein the vehicle is configured to be controlled manually or semi-autonomously by a user and the instruction is an instruction to the user to move the vehicle according to the route.

13. A movable wireless access point according to claim 11, wherein the vehicle is an autonomous vehicle and the instruction is an instruction to the autonomous vehicle to follow the route.

14. A movable wireless access point according to claim 11 wherein the controller is configured to:
send updated location data after the vehicle has moved;
receive an updated route; and
issue an instruction to move the vehicle based on the updated route.

15. A movable wireless access point according to claim 11 wherein the controller is configured to monitor one or more local network parameters and report the one or more local network parameters to the network management system, the one or more local network parameters comprising one or more of the wireless coverage in the local area, the quality of service in the local area and the user demand in the local area.

16. A movable wireless access point according to claim 15 wherein monitoring one or more local network parameters comprises monitoring one or more of the number of wireless devices connected to the movable wireless access point and/or other access points in the network, the type of connection required by devices connected to the movable access point and/or other access points in the network, the number of wireless devices in range of the wireless module and/or other access points in the network and the amount of data being transferred through the wireless module and/or other access points in the network.

17. A movable wireless access point according to claim 11 wherein:
the wireless module is configured to connect wirelessly to other movable wireless access points; and
the movable wireless access point is configured to route data received from other movable wireless access points to the network management system.

18. A movable wireless access point according to claim 11 wherein:
the wireless module is configured to connect wirelessly to a further movable wireless access point; and
connecting wirelessly to the internet comprises connecting to the internet via the wireless connection to the further movable wireless access point.

19. A movable wireless access point according to claim 11 wherein the route is received when the vehicle is parked at a first position and route is limited to be within a predefined area surrounding the first position.

20. A method of managing a movable wireless access point configured to be mounted on a vehicle and comprising a wireless module configured to connect wirelessly to the Internet and provide local wireless network coverage, the method comprising:
determining the location of the movable wireless access point;
sending location data indicating the current location of the movable wireless access point to a network management system;
receiving a route for the vehicle, the route directing the wireless access point towards one or more locations of demand for a wireless access point so that the movable wireless access point may provide wireless network coverage to the one or more locations of demand for at least part of the route; and
issuing an instruction to move the vehicle based on the route.
